(19) United States
(12) Patent Application Publication
(10) Pub. No.: US 2023/0167279 A1
(43) Pub. Date: Jun. 1, 2023

(54) CORROSION RESISTANCE OF RUBBER-BASED ADHESIVES AND SEALANTS

(71) Applicant: Henkel AG & Co. KGaA, Duesseldorf (DE)

(72) Inventors: Michael Klotz, Duesseldorf (DE); Verena Gerold, Wiesloch (DE); Slawomir Nowicki, Gaiberg (DE); Ralf Sauer, St. Leon-Rot (DE)

(21) Appl. No.: 18/162,770

(22) Filed: Feb. 1, 2023

Related U.S. Application Data
(63) Continuation of application No. PCT/EP2021/070086, filed on Jul. 19, 2021.

(30) Foreign Application Priority Data
Aug. 3, 2020 (EP) 20189086.0

(51) Int. Cl. C08L 9/00; C08L 91/00; C08K 13/02; C09J 5/06; C09J 11/04; C09J 11/06; C09J 109/00; C09J 191/00; C09D 5/08; C09D 7/63; C09D 7/61; C09D 109/00; C09D 191/00; C09K 3/10

(52) U.S. Cl. CPC C08L 9/00; C08L 91/00; C08K 13/02; C09J 5/06; C09J 11/04; C09J 11/06; C09J 109/00; C09J 191/00; C09D 5/084; C09D 7/63; C09D 7/61; C09D 109/00; C09D 191/00; C09K 3/10; C08L 2205/025; C08L 2205/035; C08L 2312/00; C08L 2207/324; C08K 2003/327

(57) ABSTRACT

The present invention relates to a hot-curing reactive composition based on natural and/or synthetic elastomers containing olefinic double bonds, and further containing at least one vulcanization system, as well as the use thereof as a one-component adhesive, sealant, as sealing compound or coating compound in vehicle construction, in particular in automotive body assembly. The present invention further relates to the use of corrosion protection pigments for improving the corrosion protection effect of such compositions.

The present invention relates to a hot-curing reactive composition based on natural and/or synthetic elastomers containing olefinic double bonds, and further containing at least one vulcanization system, as well as the use thereof as a one-component adhesive, sealant, as sealing compound or coating compound in vehicle construction, in particular in automotive body assembly. The present invention further relates to the use of corrosion protection pigments for improving the corrosion protection effect of such compositions.

In machine, vehicle or device construction, in particular in aircraft construction, rail vehicle construction or motor vehicle construction, the parts made from the various metal components and/or composite materials are increasingly joined with the aid of adhesives. In this case, for structural bonds high demands are placed on the strength of the adhesive bond. High-strength and simultaneously impact-resistant, peel-resistant and impact-peel adhesives, which are nowadays used for application in automotive body assembly, have hitherto been known primarily based on epoxides and elastomer-modified epoxides or acrylates.

In this case, these hot-curing, reactive adhesives (often also referred to as hot-melt adhesives) are applied and joined to oiled metal sheet for flanged seam bonds or overlapping bonds in the body assembly. The curing of the adhesives or sealants used here takes place later in the paint drying ovens. Prior to this, the adhesively bonded or caulked or sealed parts pass through cleaning, phosphating and dip priming stages. The adhesive or caulking or sealing agents can be rinsed out of the adhesive joints by the treatment agents used in these stages. In order to prevent this, the adhesive, caulking or sealing agent is pre-cured or rheologically adjusted accordingly by means of pre-curing mechanisms, for example using induction heaters, body assembly furnaces, infrared radiators, in order to withstand the subsequent pretreatment without being washed out. In addition, welding points can be set to strengthen the body parts. The curing of the adhesives takes place during passage through the subsequent paint ovens (for the cathodic dip coating (CDC), filler, topcoat, etc.). In general, compositions based on epoxy resins, acrylic resins and ethylene-vinyl acetate copolymers (EVA) are used. In order to counteract high raw material costs, necessary industrial hygiene markings (mostly with Xi), limited oil uptake, lack of aging resistance and lack of corrosion protection, adhesive and sealant compositions based on natural and/or synthetic (liquid) rubber are increasingly used.

At the same time, the automotive industry's requirement for the respective adhesives or sealants to be corrosion resistant is increasing steadily. In the meantime, resistances of the adhesives in the field of automotive body assembly of up to 3000 h in the salt spray test (DIN EN ISO9227) or 20 weeks VDA 621-415 in the climate change test, or more, are required. Current systems usually only fulfill up to 12 weeks VDA 621-415 in the climate change test (also specifically for aluminum SCAB corrosion cycle 40 rounds), it being attempted to improve the corrosion resistance by way of modifications of the respective polymer matrix itself

Current applications are optimized for substrates, such as cold-rolled steel or zinc-plated (hot dip or electrolytic galvanized), but the diversity of materials in automotive body assembly is increasing rapidly. Aluminum with and without TiZr treatment and also zinc-magnesium steels are increasingly used. On this broad spectrum, adhesion and corresponding corrosion resistance is a very new challenge.

One problem addressed by the present invention was therefore to provide hot-curing rubber-based adhesive compositions which are characterized by improved corrosion protection.

The accomplishment of this object according to the invention consists, in a first aspect, in the provision of a hot-curing, reactive composition based on natural and/or synthetic elastomers containing olefinic double bonds, and further containing at least one vulcanization system, characterized in that it comprises at least one corrosion protection pigment.

In a further aspect, the present invention also relates to the use of a hot-curing, reactive composition, as described herein, as a one-component adhesive, sealant or coating composition in automotive body assembly.

In a further aspect, the present invention further relates to the use of at least one corrosion protection pigment, as defined herein, for improving the corrosion protection effect of a hot-curing, reactive composition based on natural and/or synthetic elastomers containing olefinic double bonds, and further containing at least one vulcanization system.

These and further embodiments, features and advantages of the invention will become apparent to a person skilled in the art from studying the following detailed description and claims. In this case, individual described features or embodiments of the invention can be combined with other features or embodiments of the invention without these having been described in combination within the scope of the invention. It is self-evident that the examples herein are intended to describe and illustrate the invention, but do not limit the invention, and in particular the invention is not restricted to the examples.

“At least one” as used herein refers to 1 or more, for example 2, 3, 4, 5, 6, 7, 8, 9 or more. In connection with the corrosion protection pigments mentioned herein, this specification does not refer to the absolute amount of molecules, but to the type of compound. “At least one corrosion protection pigment” therefore means, for example, that only one type of corrosion protection pigment or a plurality of different types of corrosion protection pigments can be included, without stating the amount of the individual compounds.

Unless otherwise stated, all quantitative data specified in connection with the method described herein refer to wt. %, in each case based on the total weight of the composition. Furthermore, such quantity specifications, which relate to at least one component, always refer to the total amount of this type of component contained in the composition, unless explicitly stated otherwise. That is to say that such quantity specifications, for example in connection with “at least one corrosion protection pigment”, refer to the total amount of corrosion protection pigments contained in the composition, unless explicitly stated otherwise.

Numerical values, specified herein without decimal places, refer in each case to the full specified value with one decimal place. Thus, for example, “99%” stands for “99.0%”.

Numerical ranges indicated in the format “in/from x to y” include the stated values. If a plurality of preferred numerical ranges is indicated in this format, it is self-evident that all ranges that arise due to the combination of the various endpoints are also included.

“Approximately” as used herein with respect to numerical values means the corresponding value ±10%, preferably ±5%.

If reference is made herein to molar masses, these specifications always refer to the number-average molar mass Mn, unless explicitly stated otherwise. The number-average of the molar mass can, for example, be determined by means of gel permeation chromatography (GPC) according to DIN 55672-1:2007-8 using THF as the eluent. The mass-average molar mass Mw can also be determined by means of GPC, as described for Mn.

“Liquid” is understood here as “liquid at room temperature (22° C)”. In particular, the feature “liquid” is to be understood such that the respective product can be poured out of a container under the influence of gravity.

The hot-curing, reactive compositions according to the invention are based on natural and/or synthetic elastomers containing olefinic double bonds, and further containing at least one vulcanization system.

Natural or synthetic elastomers containing olefinic double bonds are generally known. In this case, polyenes of this kind contain at least one olefinically unsaturated double bond per molecule. In this case, they can be selected from the following group of homopolymers and/or copolymers: polybutadienes, in particular 1,3- and 1,2-polybutadienes, polybutenes, polyisobutylenes, 1,4- and 3,4-polyisoprenes, styrene-butadiene copolymers, butadiene-acrylonitrile copolymers, where one or more of these polymers can have terminal and/or (statistically distributed) pendant functional groups. Examples of such functional groups are hydroxy, amino, carboxyl, carboxylic anhydride or epoxy groups. In various embodiments, a composition according to the invention contains at least one liquid polyene selected from the group consisting of polybutadienes, polybutenes, polyisobutylenes, 1,4- and 3,4 polyisoprenes, styrene-butadiene copolymers and butadiene-acrylonitrile copolymers, preferably cis-1,4-polybutadiene.

The molecular weight of these liquid rubbers is typically below 80,000 and above 400, preferably between 800 and 25,000. In this case, the proportion of liquid rubber in the total composition depends on the desired rheology of the uncured composition and the desired mechanical stiffness or strength of the compound and, if applicable, the acoustic damping properties of the cured composition. The proportion of liquid rubber or elastomer normally varies between 2 and 55 wt. % of the total formulation. In this case, it has proven expedient to preferably use mixtures of liquid rubbers of different molecular weights and different configurations with respect to the remaining double bonds. In addition, both block copolymers and those with a statistical distribution of the comonomers can be used as copolymers.

In order to achieve optimal adhesion to the various substrates, in the particularly preferred formulations a liquid rubber component comprising hydroxyl groups, carboxyl groups or acid anhydride groups is used proportionally. The proportion of carboxyl group-containing liquid rubber can be 0 to 25 wt. %, preferably 1 to 15, and very particularly preferably 3 to 10 wt. %. As a further component, compositions according to the invention can contain liquid polybutadienes, preferably having a narrow molecular weight distribution, which can be prepared by anionic polymerization. These low molecular weight liquid polybutadienes contain three structural types in the polymer chain: vinylic 1,2 double bonds, cis 1,4 double bonds and trans 1,4 double bonds, these liquid polymers preferably comprising up to 80%, preferably less than 80%, vinylic 1,2 double bonds, 20 to 60% trans 1,4 double bonds, and 10 to 35% cis 1,4 double bonds in their microstructure.

The molecular weights of these liquid butadienes are between 2000 and 12,000, preferably between 5,000 and 9,000 (number-average molecular weight). Due to their narrow molecular weight distribution, they have a very low viscosity of between 3 and 15 Pa s at 25° C. Depending on the anionic polymerization, they may optionally have one or two terminal or one or more statistically distributed hydroxyl group(s) per molecule. Alternatively, these polymers can also have one or two terminal or one or more statistically distributed carboxyl group(s). The advantage of using these liquid polybutadienes having a narrow molecular weight distribution is a higher molecular weight compared to customary liquid polybutadienes having a nevertheless low viscosity.

In addition, the composition according to the invention can also contain a proportion of solid rubbers. Suitable solid rubbers have a significantly higher molecular weight compared to the liquid rubbers (MW=100,000 or higher). Examples of suitable rubbers are polybutadiene, preferably having a very high proportion of cis 1,4 double bonds (typically over 95%), styrene-butadiene rubber, butadiene-acrylonitrile rubber, synthetic or natural isoprene rubber, polycyclooctenamer, butyl rubber or polyurethane rubber. In this case, the proportion of solid rubber can be 15 wt. %, preferably is between 0 and 12 wt. %, and very particularly preferably between 0 and 9 wt. %.

In various embodiments, a composition according to the invention comprises at least one solid rubber from the group cis 1,4-polybutadiene, styrene-butadiene rubber, synthetic isoprene rubber, natural rubber, ethylene propylene diene rubber (EPDM), polycyclooctenamer, nitrile rubber, butyl rubber, acrylic rubber or polychloroprene.

The vulcanization system can be selected from the vulcanization systems known for the vulcanization of rubber. Thus, according to alternative b1), it can contain sulfur and one or more accelerators.

In this case, the sulfur in powder form is preferably used in amounts of 0.5 to 6.5 wt. %, based on the total composition. Particularly preferably, amounts between 1 and 4 wt. % are used. Suitable organic accelerators are dithiocarbamates (in the form of their ammonium or metal salts), xanthogenates, thiuram compounds (monosulfides and disulfides), thiazole compounds, aldehyde/amine accelerators (for example hexamethylenetetramine) and guanidine accelerators. Very particular preference is given to dibenzothiazyl disulfide (MBTS), 2-mercaptobenzothiazole (MBT), the zinc salt thereof (ZMBT), zinc dibenzyl dithiocarbamate (ZBEC), n-cyclohexylbenzodothioazylsulfenamide (CBS) or diphenylguanidine. The accelerators, including the further zinc compounds mentioned above and in the following paragraph, are preferably used in amounts between 0.25 and 20 wt. %, particularly preferably between 0.8 and 12 wt. %. In order to achieve particularly high temperature and reversion strength of the adhesive, the vulcanization mixture can also contain bifunctional crosslinkers. Specific examples are crosslinkers based on bifunctional dithiocarbamates, such as 1,6-bis (N,N-dibenzylthiocarbamoyldithio)-hexane. Crosslinkers of this kind can be contained in the compositions in amounts between 0 and 2, preferably between 0 and 1 wt. %.

The zinc compounds acting as accelerators can be selected from the zinc salts of fatty acids, zinc dithiocarbamates, basic zinc carbonates and especially finely divided zinc oxide. The content of zinc compounds is in the range between 0.5 and 10 wt. %, preferably between 2 and 8 wt. %. These zinc compounds can be, and preferably also are, used in combination with the accelerators mentioned in the above paragraph. In addition, further typical rubber vulcanization aids such as fatty acids (e.g. stearic acid) may be present in the formulation.

However, the vulcanization system can also be free of elemental sulfur. For example, as vulcanization system b2) peroxides can be used, preferably organic peroxides, as are known for this purpose.

Non-limiting examples of suitable compounds are: dibenzoyl peroxide, tert-butyl peroxybenzoate, and in particular 1,1-di-(tert-butylperoxy)-3,3,5-trimethylcyclohexane, butyl-4,4-di-(tert-butylperoxy) valerate, dicumyl peroxide, di-(2-tert-butyl peroxyisopropyl) benzene, tert-butyl cumyl peroxide, 2,5-dimethyl-2,5-di-(tert-butylperoxy) hexane, di-tert-butyl peroxide,3,3,5,7,7-pentamethyl-1,2,4, trioxepane, tert-butyl peroxy-2-ethylhexyl carbonate, di(4-methylbenzoyl) peroxide, di(2,4-dichlorobenzoyl) peroxide, 2,5-dimethyl-2,5-di(tert-butylperoxyl) hexane and di-tert-butyl-1,1,4,4-tetramethylbut-2-yn-1,4-ylene peroxide, and further crosslinking aids, such as triallyl isocyanurate.

In various embodiments, the vulcanization system is a peroxide-based vulcanization system. In corresponding embodiments, the at least one peroxide compound, contained in a composition according to the invention, is preferably selected from the group consisting of dibenzoyl peroxide, tert-butyl peroxybenzoate, and in particular 1,1-di-(tert-butylperoxy)-3,3,5-trimethylcyclohexane, butyl-4,4-di-(tert-butylperoxy) valerate, dicumyl peroxide, di-(2-tert-butyl peroxyisopropyl) benzene, tert-butyl cumyl peroxide, 2,5-dimethyl-2,5-di-(tert-butylperoxy) hexane, di-tert-butyl peroxide, 3,3,5,7,7-pentamethyl-1,2,4trioxepane, tert-butyl peroxy2-ethylhexyl carbonate, di(4-methylbenzoyl) peroxide, di(2,4-dichlorobenzoyl) peroxide, 2,5-dimethyl-2,5-di(tert-butylperoxyl) hexane and di-tert-butyl-1,1,4,4-tetramethylbut-2-yn-1,4-ylene peroxide.

In some embodiments, the amount of peroxide compound is approximately 0.1 wt. % to approximately 7 wt. %, for example approximately 0.1, 0.2, 0.3, 0.4, 0.5, 0.6, 0.7, 0.8, 0.9, 1.0, 1.5, 2.0, 2.5, 3.0, 3.5, 4.0, 4, 5, 5.0, 5.5, 6.0, 6.5 or 7.0 wt. %, preferably approximately 0.1 wt. % to approximately 5 wt. %, for example approximately 0.15, 0.25, 0.35, 0.45, 0.55, 0.65, 0.75, 0.85, 0.95, 1.05, 1.1, 1.2, 1.4, 1.7, 1.9, 2.1, 2.4, 2.6, 2.8, 3.3, 3.7, 4.1, 4.6, 4.9 or 5.0 wt. %, based in each case on the total weight of the composition

In various embodiments, the vulcanization system is a peroxide-based vulcanization system and the composition according to the invention contains at least one peroxide compound in an amount of approximately 0.1 wt. % to approximately 7 wt. %, preferably approximately 0.1 wt. % to approximately 5 wt. %, in each case based on the total weight of the composition.

Instead of peroxides, it is also possible to use “disulfidic” vulcanization systems, i.e. vulcanization systems based on disulfides. Thiuram disulfides are suitable, for example. The amounts used in the case of disulfides are preferably 0.2-5 wt. %.

As a further alternative, as vulcanization system b3), quinones, quinone dioximes, in particular p-benzoquinone dioxime, nitrosobenzene or dinitrosobenzene, in particular p-dinitrosobenzene are used. These are also known from the vulcanization of rubber.

According to the invention, a combined vulcanization system of elemental sulfur, the above-mentioned organic accelerators, and quinone dioximes can also be used. By way of example, p-benzoquinone dioxime is mentioned. However, other quinone dioximes in combination with the aforementioned sulfur systems can also be used. The vulcanization system can also consist only of quinone dioximes. The amount used is preferably 0.2-6.0 wt. %, more preferably 1.5-6.0 wt. %, in particular for quinone dioximes, irrespective of whether or not these are used together with sulfur.

In various embodiments, the at least one vulcanization system is accordingly selected from the group consisting of sulfur and one or more accelerators; one or more peroxides, preferably organic peroxides; disulfide vulcanization systems; and quinones, quinone dioximes, nitrosobenzene and/or dinitrosobenzene.

A further essential component according to the invention is at least one pigment component selected from the group of corrosion protection pigments. The term “corrosion protection pigment”, as used in the context of the present invention, relates to various types of pigments, such as are usually used in paints, lacquers and/or (metallic) coatings for the purpose of optimizing corrosion protection. In various embodiments, the at least one corrosion protection pigment of a composition according to the invention is a metal phosphate salt. In further such embodiments, the at least one metal phosphate salt is a metal orthophosphate salt, a metal triphosphate salt or a metal polyphosphate salt. In the context of the present invention, the term “metal phosphate salt” also includes the hydrates of corresponding salts. In various embodiments, the at least one metal phosphate salt comprises at least one metal cation selected from the group of alkali metal cations, alkaline earth metal cations, transition metal cations and metal cations of the boron group. In preferred embodiments, the at least one metal cation is a cation of a metal selected from the group consisting of Zn, Al, Ca, Sr, Mo, Ba and Pb, preferably from the group consisting of Zn, Al, Ca, Sr and Mo. In various embodiments, the at least one metal phosphate salt contains at least two different metal cations, as defined above.

Non-limiting examples of corrosion protection pigments suitable in the context of the present invention, preferably metal phosphate salts, include aluminum polyphosphate compounds, zinc aluminum orthophosphate, zinc orthophosphate hydrate, zinc molybdenum orthophosphate hydrate, calcium phosphate complexes, zinc aluminum polyphosphate hydrate, strontium aluminum polyphosphate hydrate and aluminum triphosphate. Accordingly, the at least one corrosion protection pigment is selected in various embodiments from the group consisting of aluminum polyphosphate compounds, zinc aluminum orthophosphate, zinc orthophosphate hydrate, zinc molybdenum orthophosphate hydrate, calcium phosphate complexes, zinc aluminum polyphosphate hydrate, strontium aluminum polyphosphate hydrate and aluminum triphosphate.

In some embodiments, the amount of the at least one corrosion protection pigment is approximately 0.1 to approximately 10 wt. %, for example approximately 0.1, 0.2, 0.3, 0.4, 0.5, 0.6, 0.7, 0.8, 0.9, 1.0, 1.5, 2.0, 2.5, 3.0, 3.5, 4.0, 5.0, 6.0, 7.0, 8.5, 9.0, 9.5 or 10.0 wt. %, preferably approximately 3.0 to approximately 8.0 wt. %, for example approximately 3.0, 3.1, 3.2, 3.3, 3.4, 3.5, 3.6, 3.7, 3.8, 3.9, 4.0, 4.1, 4.2, 4.6, 5.2, 5.5, 6.2, 6.5, 7.2, 7.5, or 8.0 wt. %, in each case based on the total weight of the composition.

Furthermore, hot-curing, reactive compositions according to the invention can contain at least one crosslinking agent comprising multiple (meth)acryloyl groups. Such crosslinking agents can be used to increase the tensile strength of the material.

Crosslinking agents comprising multiple (meth)acryloyl groups are known in the prior art and can be selected, for example and without restriction, from di(meth)acrylates, tri(meth)acrylates, tetra(meth)acrylates and penta(meth)acrylates and the like. Such crosslinking agents can be formed, for example, by reaction of (meth)acrylic acid with a polyhydric alcohol (i.e., an alcohol having at least two hydroxyl groups). The polyhydric alcohol often has two, three, four or five hydroxyl groups. In principle, mixtures of crosslinking agents can also be used.

In various embodiments, the crosslinking agents contain at least two (meth)acryloyl groups. Examples of crosslinking agents having two acryloyl groups include 1,2-ethanediol diacrylate, 1,3-propanediol diacrylate, 1,9-non-butanediol diacrylate, 1,12-dodecanediol diacrylate, 1,4-butanediol diacrylate, 1,6-hexanediol diacrylate, butylene glycol diacrylate, bisphenol A diacrylate, diethylene glycol diacrylate, triethylene glycol diacrylate, tetraethylene glycol diacrylate, tripropylene glycol diacrylate, polyethylene glycol diacrylate, polypropylene glycol diacrylate, polyethylene/polypropylene copolymer diacrylate, polybutadiene di(meth)acrylate, propoxylated glycerol tri(meth)acrylate and caprolactan modified with neopentyl glycol hydroxypivalate diacrylate.

Examples of crosslinking agents having three or four (meth)acryloyl groups include, inter alia, trimethylolpropane triacrylate (e.g. commercially available under the trade name TMPTA-N from Cytec Industries, Inc., Smyra, Ga. and under the trade name SR-351 from Sartomer, Exton, Pa.), trimethylolpropane trimethacrylate (e.g. commercially available under the trade name SR-350 from Sartomer, Exton, PA), pentaerythritol triacrylate (e.g. commercially available under the trade name SR-444 from Sartomer), tris(2-hydroxyethyl isocyanurate) triacrylate (e.g. commercially available under the trade name SR-368 from Sartomer), a mixture of pentaerythritol triacrylate and pentaerythritol tetraacrylate (e.g. commercially available from Cytec Industries, Inc. under the trade name PETIA with a ratio of tetraacrylate to triacrylate of approximately 1:1 and under the trade name PETA-K with a ratio of tetraacrylate to triacrylate of approximately 3:1), pentaerythritol tetraacrylate (e.g. commercially available under the trade name SR-295 from Sartomer), di-trimethylolpropane tetraacrylate (e.g. commercially available under the trade name SR-355 from Sartomer) and ethoxylated pentaerythritol tetraacrylate (e.g. commercially available under the trade name SR-494 from Sartomer).

An example of a crosslinking agent having five (meth)acryloyl groups is dipentaerythritol pentaacrylate (e.g. commercially available under the trade name SR-399 from Sartomer).

The amount of crosslinking agents of this type is usually in the range of approximately 0.1 to approximately 5 wt. %. In some embodiments, the at least one crosslinking agent comprising (meth)acryloyl groups as defined above is contained in an amount of about 0.1 wt. % to approximately 5 wt. %, for example in an amount of approximately 0.1, 0.2, 0.3, 0.4, 0.5, 0.6, 0.7, 0.8, 0.9, 1.0, 1.5, 2.0, 2.5, 3.0, 3.5, 4.0, 4, 5 or 5.0 wt. %, preferably approximately 0.1 wt. % to approximately 2 wt. %, for example approximately 0.15, 0.25, 0.35, 0.45, 0.55, 0.65, 0.75, 0.85, 0.95, 1.05, 1.1, 1.2, 1.3, 1.4, 1.5, 1.6, 1.7, 1.8, 1.9, 2.0, 2.1, 2.2, 2.3, 3.4, 2.5, 2.6, 2.7, 2.8, 2.9 or 3.0 wt. %, based in each case on the total weight of the composition.

In addition, the compositions according to the invention for rubber mixtures can comprise conventional fillers, accelerators, further crosslinking agents, antioxidants, co-activators and further catalysts, soot, blowing agents, oils, aging inhibitors, fibers, optionally also graphite, rheological aids, adhesion promoters, pigments and thermoplastic polymers.

In various embodiments, a composition according to the invention contains at least one further component selected from fillers, rheological aids, extender oils, blowing agents, further pigments, adhesion promoters and/or aging inhibitors.

The compositions according to the invention can further comprise finely divided thermoplastic polymer powders. These should have a glass transition temperature in the range between −80° C. and 50° C. Examples of suitable thermoplastic polymers are polypropylene, polyethylene, thermoplastic polyurethanes, (meth)acrylate copolymers, styrene copolymers, polyvinyl chloride, polyvinyl acetal and polyvinyl acetate and the copolymers thereof, in particular ethylene vinyl acetate (EVA). Although the particle size or particle size distribution of the thermoplastic polymer powder is not particularly critical, the average particle size should be under 1 mm, preferably under 350 μm, particularly preferably between 100 and 20 μm. When thermoplastic polymer powders are also used, their proportion of the total formulation is between 1 and 20 wt. %, preferably between 5 and 15 wt. %.

The fillers can be selected from a plurality of materials; in particular, chalk, natural or ground calcium carbonates, calcium magnesium carbonates, silicates, talcum, heavy spar and carbon black can be cited. It may optionally be expedient for at least a portion of the fillers to be surface-pretreated, in particular a coating with stearic acid for reducing the absorbed moisture and for reducing the moisture sensitivity of the cured composition has proven expedient for the various calcium carbonates or chalks. The compositions according to the invention can still contain between 0 and 8 wt. %, preferably between 1 and 6 wt. % calcium oxide. The total proportion of fillers in the formulation can be between 10 and 80 wt. %, the preferred range is between 20 and 65 wt. %.

Conventional stabilizers or aging inhibitors, such as sterically hindered phenols (for example, 2,2-methylene-bis-(4-methyl-6-tert-butylphenol) or amine derivatives, can be used against the thermal, thermooxidative or ozone depletion of the compositions according to the invention; typical quantity ranges for these stabilizers are 0 to 2 wt. %.

Although the rheology of the compositions according to the invention can also be brought into the desired range by the selection of the fillers and the quantity ratio of the low molecular weight liquid rubbers, conventional rheological aids, such as fumed silicas, bentones or fibrillated or pulp short fibers, can be added in the range between 0.1 and 7% or also hydrogenated castor oil derivatives, known for example under the trade names Rilanit (Company Cognis). Furthermore, further conventional auxiliaries and additives can be used in the compositions according to the invention.

In order to achieve the foaming during the curing process, all common blowing agents can in principle be used, but preferably organic blowing agents from the class of azo compounds, n-nitroso compounds, sulfonylhydrazides or sulfonylsemicarbazides. For the azo compounds to be used according to the invention, mention may be made by way of example to azobisisobutyronitrile and in particular azodicarbonamide, from the class of the nitro compounds, for example di-nitrosopentamethylenetetramine, from the class of the sulfohydrazides 4,4′-oxybis (benzenesulfonic acid hydrazide), diphenyl sulfone-3,3′-disulfohydrazide, or benzene-1,3-disulfohydrazide, and from the class of the semicarbazides, p-toluenesulfonyl semicarbazide.

In place of the above-mentioned blowing agents, it is possible to use what are known as expandable microspheres, i.e., non-expanded thermoplastic polymer powders, which are soaked or filled with low-boiling organic liquids. Such “microspheres” are, for example, described in EP-A 559254, EP-A-586541or EP-A-594598. Although not preferred, already expanded hollow microspheres can also be used or used together therewith. These expandable/expanded microspheres may optionally be combined with the above-mentioned “chemical” blowing agents in any quantity ratio. The chemical blowing agents are used in foamable compositions in amounts between 0.1 and 3 wt. %, preferably between 0.2 and 2 wt. %, the hollow microspheres between 0.1 and 4 wt. %, preferably between 0.2 and 2 wt. %.

Although the compositions according to the invention generally have very good adhesion to the substrates due to the preferred content of liquid rubber comprising functional groups, tackifiers and/or adhesion promoters can be added, if necessary. For example, hydrocarbon resins, phenolic resins, terpene-phenolic resins, resorcinol resins or derivatives thereof, modified or unmodified resin acids or esters (abietic acid derivatives), polyamines, polyaminoamides, anhydrides and anhydride-containing copolymers are suitable for this purpose. The addition of polyepoxy resins in small amounts can also improve adhesion in some substrates. However, the solid epoxy resins having a molecular weight of over 700, in finely ground form, are then preferably used for this purpose. If tackifiers or adhesion promoters are used, their type and amount depends on the polymer composition and the substrate to which the composition is applied. Typical tackifying resins (tackifiers), such as terpene-phenol resins or resin acid derivatives, are used in concentrations between 5 and 20 wt. %, typical adhesion promoters, such as polyamines, polyaminoamides or phenolic resins or resorcinol derivatives, are used in the range between 0.1 and 10 wt. %.

In various embodiments, the compositions according to the invention are free of plasticizers and extender oils. However, it may be necessary to influence the rheology of the uncured composition and/or the mechanical properties of the cured composition by adding what are known as extender oils, i.e. aliphatic, aromatic or naphthenic oils. Preferably, this influence occurs by appropriate selection of low molecular weight liquid rubbers or by the co-use of low molecular weight polybutenes or polyisobutylenes. If extender oils are used, amounts in the range between 2 and 15 wt. % are used.

In order to achieve corrosion-resistant rubber mixtures, the compositions according to the invention preferably contain amounts of components as recited below in Table 1(specification in wt. %):

TABLE 1

| | | | Particularly |
|---|---|---|---|
| | General | Preferred | preferred |
| Component | composition | composition | composition |
| Solid rubber | 0-12% | 0.1-9% | 1.5-6.5% |
| Polybutadiene, | 1-20% | 2-10% | 2.5-8% |
| Maleic anhydride-grafted | | | |
| Liquid polybutadiene, | 2-50% | 4-45% | 5-35% |
| cis 1,4-proportion > 80% | | | |
| Liquid polybutadiene 1,2 | 0-10% | 0-8% | 0-6% |
| Vinyl proportion > | | | |
| 50% (up to 80%) | | | |
| Softening agent | 0-40% | 2-30% | 5-25% |
| Hydrocarbon resin | 0-40% | 2-30% | 5-25% |
| Vulcanization agent | 0.1-7% | 0.2-5.0% | 0.5-3.0% |
| (e.g. peroxide compound(s)) | | | |
| Vulcanization accelerator | 0.25-8% | 0.5-5% | 0.8-4% |
| Bifunctional vulcanization | 0-2% | 0-1% | 0.25-1% |
| crosslinker | | | |
| Crosslinker containing | 0.1-5% | 0.1-2% | 0.5-2% |
| multiple (meth)acryloyl | | | |
| groups | | | |
| Corrosion protection pigment | 0.1-10% | 1-8% | 2-6% |
| Chemical blowing agent | 0-6% | 0.2-4% | 0.5-3% |
| (incl. activator) | | | |
| Physical blowing agent | 0-6% | 0-4% | 0-1.5% |
| Zinc oxide | 0-10% | 0-8% | 0.5-7% |
| Antioxidant (e.g. 2,2- | 0-1.5% | 0.1-1.0% | 0.2-0.7% |
| methylene-bis-(4-methyl | | | |
| tert-butylphenol) | | | |
| Calcium oxide | 0-8% | 1-6% | 2.5-5.5% |
| Carbon black | 0-5% | 0.1-3% | 0.2-2% |
| Filler (calcium | 10-45% | 15-45% | 25-40% |
| carbonate, graphite, | | | |
| talcum, mica, etc.) | | | |
| Calcium carbonate, coated | 0-30% | 0-18% | 0-12% |

In addition, as mentioned above, further fillers, such as fibers, silicates, aluminas, further typical accelerators, other antioxidants, co-activators and further catalysts, blowing agents, oils, aging inhibitors, can also be used. Optionally, rheological aids, adhesion promoters, further pigments and thermoplastic polymers (SEPS, SEEPS, PE, PP, PVC, TPU) may also be contained in the composition. The sum of the components of the composition is supplemented in any case to 100%.

The hot-curing, reactive one-component adhesives according to the invention can be used, like the previously known adhesives based on rubber, in body assembly, for example for flanged seam bonds or overlapping adhesive bonds. They can be applied to oiled metal sheets, as are used in automotive body assembly, and the components are subsequently joined. The compositions according to the invention generally do not require pre-curing mechanisms, such as induction heating, body assembly furnaces or IR emitters for pre-curing, since they are washer-resistant like the previously known rubber compositions. Compared to the previously known rubber compositions, they have a very much higher corrosion resistance.

This property is desirable so that the structurally glued components correspond to the modern requirements in vehicle construction. Because the compositions according to the invention can be formulated without expensive special polymers or copolymers, they can be manufactured particularly cost-effectively.

The compositions according to the invention can be produced in a known manner in mixing units having a high shear effect, including for example kneaders, planetary mixers, internal mixers, “Banbury mixers” and similar mixing units known to a person skilled in the art.

The compositions are used in particular as relining and as an adhesive and sealant for attachments, such as doors, front panel and tailgate, roof, front and floor regions, but also directly in the passenger compartment for vehicles (motor vehicles, trucks, bus) or for the manufacture of rail vehicles. They can also be used in equipment construction. Therefore, the present invention also includes the use of a composition according to the invention as a corrosion-resistant material in vehicle or equipment construction. In particular, the hot-curing, reactive composition, as disclosed and described herein, is used as a one-component adhesive, sealant or as a coating composition in automotive body assembly.

Moreover, it is self-evident that all embodiments disclosed above in connection with the described compositions are also applicable in the described uses and the correspondingly cured compositions, and vice versa.

Accordingly, in a further aspect, the present invention also relates to the use of at least one corrosion protection pigment for improving the corrosion protection of a hot-curing, reactive composition based on natural and/or synthetic elastomers containing olefinic double bonds, and further containing at least one vulcanization system, as described above, wherein all embodiments disclosed above in connection with the described compositions are also applicable accordingly to the use of the described corrosion protection pigments.

The invention is to be disclosed in more detail in the following embodiments, the selection of the examples not being intended to represent a limitation of the scope of the subject matter of the invention.

### EXAMPLES

All quantity specifications listed in the Tables are in wt. %

TABLE 2
b2)-based cure

| Component | Example 1 | Example 2 | Example 3 | Example 4 |
|---|---|---|---|---|
| Solid polybutadiene; | 5.90 | 4.50 | 5.90 | 4.00 |
| cis-1,4 proportion > 95% | | | | |
| Maleic anhydride- | 4.80 | 6.00 | 6.00 | 4.00 |
| grafted polybutadiene | | | | |
| Liquid polybutadiene, | 16.25 | 20.50 | 18.00 | 12.25 |
| cis-1,4 proportion > 80% | | | | |
| Talc | 17.58 | | | |
| Calcium carbonate | 16.42 | 38.37 | 34.50 | 42.15 |
| Coated calcium | 17.20 | 17.60 | 17.20 | 17.20 |
| carbonate | | | | |
| Calcium dioxide | 4.80 | 4.78 | 4.80 | 4.80 |
| Mineral oil | 6.25 | | | 10.25 |
| Antioxidant | 0.30 | 0.40 | 0.30 | 0.05 |
| Amorphous | 0.30 | 0.20 | 0.30 | 0.30 |
| carbon black | | | | |
| Expanding hollow | 0.10 | 0.15 | | 0.60 |
| microspheres | | | | |
| Benzenesulfinic | | | 0.10 | |
| acid zinc salt | | | | |
| Azodicarbonamide | | | 1.00 | |
| Aluminum triphosphate | 5.00 | 5.00 | 4.00 | 2.00 |
| Aromatic hydrocarbon | 2.00 | | 5.00 | |
| resin in oil | | | | |
| Silica, hydrophobic | | 0.50 | | |
| Liquid polybutadiene, | | | 1.00 | |
| 1,2 vinyl | | | | |
| Peroxide | 1.40 | 1.00 | 1.40 | 1.40 |
| Acrylate monomer | 1.70 | 1.00 | 0.50 | 1.00 |
| co-agent | | | | |

TABLE 3
b1)-based cure

| Component | Example 5 | Example 6 | Example 7 | Example 8 |
|---|---|---|---|---|
| Solid polybutadiene; | 5.00 | 7.8 | 6.1 | 6.00 |
| cis-1,4 proportion > 95% | | | | |
| Maleic anhydride- | 4.00 | 4.3 | 6.1 | 6.0 |
| grafted polybutadiene | | | | |
| Liquid polybutadiene, | 18.14 | 24.48 | 6.1 | 22.4 |
| cis-1,4 proportion > 80% | | | | |
| Talc | | | | |
| Calcium carbonate | 44.27 | 32.81 | 26.8 | 25.95 |
| Coated calcium | 12.04 | 18.7 | 20.4 | 13.2 |
| carbonate | | | | |
| Calcium dioxide | 2.9 | 2.5 | 2.55 | 8.00 |
| Mineral oil | 5.00 | | 20.47 | |
| Antioxidant | 0.30 | 0.3 | 0.50 | 0.50 |
| Amorphous | 0.37 | 0.3 | 2.0 | 0.50 |
| carbon black | | | | |
| Expanding hollow | 0.22 | 0.62 | 1.02 | 0.2 |
| microspheres | | | | |
| Benzenesulfinic | | 0.1 | 0.17 | |
| acid zinc salt | | | | |
| Azodicarbonamide | | 0.8 | 1.53 | |
| Aluminum triphosphate | 1.16 | 1.19 | 3.24 | 6.40 |
| Aromatic hydrocarbon | | | | |
| resin in oil | | | | |
| Silica, hydrophobic | | | | |
| Liquid polybutadiene; | | 2.2 | | |
| 1,2 vinyl proportion > | | | | |
| Sulfur | 3.50 | 2.5 | 1.02 | 3.75 |
| Organic accelerator | 3.00 | 1.1 | 1.2 | 5.00 |
| Acrylate monomer | 0.1 | 0.3 | 0.8 | 2.1 |
| co-agent | | | | |

TABLE 4
b3)-based cure

| Component | Example 9 | Example 10 |
|---|---|---|
| Solid polybutadiene; | 5.00 | 6.35 |
| cis-1,4 proportion > 95% | | |
| Maleic anhydride- | 1.73 | 1.2 |
| grafted polybutadiene | | |
| Liquid polybutadiene, | 5.0 | 24.1 |
| cis-1,4 proportion > 80% | | |
| Talc | | |
| Calcium carbonate | 49.2 | 40.53 |
| Coated calcium | 12.0 | 11.9 |
| carbonate | | |
| Calcium dioxide | 2.5 | 2.0 |
| Mineral oil | 20.00 | |
| Antioxidant | 0.5 | 0.1 |
| Amorphous | 2.00 | 0.3 |
| carbon black | | |
| Expanding hollow | 0.23 | |
| microspheres | | |
| Benzenesulfinic | 0.1 | |
| acid zinc salt | | |
| Azodicarbonamide | 0.3 | |
| Di-nitrosopentamethylenetetramine | | 0.2 |
| Aluminum triphosphate | 0.65 | 3 |
| Aromatic hydrocarbon | | |
| resin in oil | | |
| Silica, hydrophobic | | 9.23 |
| Liquid polybutadiene; | | |
| 1,2 vinyl proportion > 50% | | |
| Benzoquinone dioxime | 0.39 | 0.99 |
| Acrylate monomer | 0.4 | 0.1 |
| co-agent | | |

1. A hot-curing, reactive composition based on natural and/or synthetic elastomers containing olefinic double bonds, wherein the hot-curing, reactive composition further comprises at least one vulcanization system and at least one corrosion protection pigment.

2. The hot-curing reactive composition according to claim 1, wherein the at least one corrosion protection pigment comprises at least one metal phosphate salt.

3. The hot-curing reactive composition according to claim 2, wherein the at least one corrosion protection pigment is present in an amount of from approximately 3.0 wt. % to approximately 8.0 wt. %, in each case based on total weight of the composition.

4. The hot-curing reactive composition according to claim 2, wherein the at least one metal phosphate salt is a metal orthophosphate salt, a metal triphosphate salt, a metal polyphosphate salt or mixtures thereof; and/or
the at least one metal phosphate salt comprises at least one metal cation selected from alkali metal cations, alkaline earth metal cations, transition metal cations and cations of the boron group.

5. The hot-curing reactive composition according to claim 4, wherein the at least one metal cation is a cation of a metal selected from the group consisting of Zn, Al, Ca, Sr, Mo, Ba and Pb.

6. The hot-curing, reactive composition according to claim 1, wherein the at least one corrosion protection pigment is selected from the group consisting of an aluminum polyphosphate compound, zinc aluminum orthophosphate, zinc orthophosphate hydrate, zinc molybdenum orthophosphate hydrate, a calcium phosphate complex, zinc aluminum polyphosphate hydrate, strontium aluminum polyphosphate hydrate, aluminum triphosphate and combinations thereof.

7. The hot-curing reactive composition according to claim 6, wherein the at least one corrosion protection pigment is present in an amount of from approximately 0.1 wt. % to approximately 10 wt. %, in each case based on total weight of the composition.

8. The hot-curing, reactive composition according to claim 1, wherein the natural and/or synthetic elastomers containing olefinic double bonds comprise at least one liquid polyene selected from the group consisting of polybutadienes, polybutenes, polyisobutylenes, 1,4- and 3,4-polyisoprenes, styrene-butadiene copolymers, butadiene-acrylonitrile copolymers and combinations thereof.

9. The hot-curing, reactive composition according to claim 8, wherein the natural and/or synthetic elastomers containing olefinic double bonds comprise at least one solid rubber from the group cis-1,4-polybutadiene, styrene-butadiene rubber, synthetic isoprene rubber, natural rubber, ethylene propylene diene rubber (EPDM), polycyclooctenamer, nitrile rubber, butyl rubber, acrylic rubber or polychloroprene.

10. The hot-curing reactive composition according to claim 9, wherein the at least one corrosion protection pigment is contained in an amount of from approximately 0.1 to approximately 10 wt. %, based on total weight of the composition.

11. The hot-curing reactive composition according to claim 1, wherein the at least one vulcanization system is selected from the group consisting of b1) sulfur and one or more accelerators; b2) one or more peroxides or disulfide vulcanization systems; and b3) quinones, quinone dioximes, nitrosobenzene and/or dinitrosobenzene.

12. The hot-curing reactive composition according to claim 1, wherein the at least one vulcanization system is a peroxide-based vulcanization system and the composition contains at least one organic peroxide compound present in an amount of approximately 0.1 wt. % to approximately 5 wt. %, in each case based on total weight of the composition.

13. The hot-curing, reactive composition according to claim 1, wherein the hot-curing, reactive composition further comprises at least one crosslinking agent containing multiple (meth)acryloyl groups.

14. The hot-curing reactive composition according to claim 13, wherein the at least one crosslinking agent containing multiple (meth)acryloyl groups is present in an amount of approximately 0.1 wt. % to approximately 5 wt. %, in each case based on total weight of the composition.

15. The hot-curing, reactive composition according to claim 1, wherein the hot-curing, reactive composition additionally contains fillers, rheological aids, extender oils, blowing agents, further pigments different from the corrosion protection pigment, adhesion promoters and/or aging inhibitors.

16. A hot-curing, reactive composition comprising components in weight %:
a. A solid rubber present in an amount of about 0.1-9%;
b. A maleic anhydride-grafted polybutadiene, present in an amount of about 1-20%;
c. A liquid polybutadiene, having a cis 1,4-proportion of more than 80%, present in an amount of about 2-50%;
d. A vulcanization agent present in an amount of about 0.1-7%;
e. A vulcanization accelerator present in an amount of about 0.25-8%;
f. A crosslinker containing multiple (meth)acryloyl groups present in an amount of about 0.1-5%
g. A corrosion protection pigment present in an amount of about 0.1-10%
h. Filler present in an amount of about 10-65%;
and optionally
0-10% of a second liquid polybutadiene, having a 1,2 vinyl proportion of more than 50% up to about 80%;
0-40% Softening agent;
0-40% Hydrocarbon resin;
0-2% Bifunctional vulcanization crosslinker;
0-6% Chemical blowing agent/activator;
0-6% Physical blowing agent;
0-10% Zinc oxide; and
0-1.5% Antioxidant.

17. A one-component adhesive, sealant or coating composition comprising the hot-curing, reactive composition according to claim 1.

18. A method of assembling an automotive body comprising steps of: applying the one-component adhesive, sealant or coating composition comprising the hot-curing, reactive composition according to claim 17 to automotive body components, optionally joining the components; and hot-curing the adhesive, sealant or coating composition thereby forming a cured adhesive, sealant or coating.

19. A method of improving metal corrosion protection effect of a hot-curing, reactive composition which comprises natural and/or synthetic elastomers containing olefinic double bonds and a vulcanization system, the method comprising a step of adding at least one corrosion protection pigment comprising at least one metal phosphate salt prior to application and hot-curing of the composition, wherein the at least one metal phosphate salt is present in an amount of from approximately 0.1 wt. % to approximately 10 wt. %, in each case based on total weight of the composition.
